(19) United States
(12) Patent Application Publication
(10) Pub. No.: US 2017/0297297 A1
(43) Pub. Date: Oct. 19, 2017

(54) COMPOSITE GYPSUM PANEL DERIVED FROM URETHANE BASED ADHESIVES

(71) Applicant: United Innovative Solutions, LLC, Lawrenceville, GA (US)

(72) Inventors: Frank A. Queen, Dacula, GA (US); Robert Keith Salsman, Hoschton, GA (US)

(21) Appl. No.: 15/487,462

(22) Filed: Apr. 14, 2017

Related U.S. Application Data
(60) Provisional application No. 62/322,925, filed on Apr. 15, 2016.

(51) Int. Cl. B32B 5/18; B32B 37/14; E04B 1/94; E04B 1/80; E04C 2/04; B32B 7/12; B32B 27/40; E04B 1/86

(52) U.S. Cl. CPC B32B 5/18; B32B 27/40; B32B 37/14; E04B 1/86; E04B 1/80; E04C 2/04; B32B 7/12; E04B 1/942; B32B 2266/0278; B32B 2266/08; B32B 2607/00; B32B 2307/3065

(57) ABSTRACT

Composite gypsum panels and methods of making thereof are provided. The composite gypsum panels can include one or more gypsum panel substrates having one or more urethane layers applied thereto. The urethane layers can be or can include foamed urethane layers, provided for structural integrity while being lighter than conventional gypsum panels having the same overall thickness. The panel can have a dense coating layer, a foamed coating layer, or both a dense coating layer and a foamed coating layer. The dense coating layers and foamed coating layers can each offer certain advantages over conventional gypsum panels. Additionally, in various aspects, the composite panel includes a water-resistant barrier and increased nail and screw retention.

### CROSS-REFERENCE TO RELATED APPLICATIONS

This application claims priority to, and the benefit of, co-pending U.S. provisional application entitled “COMPOSITE GYPSUM PANEL DERIVED FROM URETHANE BASED ADHESIVES” having Ser. No. 62/322,925, filed Apr. 15, 2016, the contents of which are incorporated by reference in their entirety.

### FIELD OF THE DISCLOSURE

The present disclosure relates generally to drywall panels used, for example, in interior walls and ceilings in residential and commercial building applications.

### BACKGROUND OF THE DISCLOSURE

Drywall (also known as plasterboard, wallboard and gypsum board) is made of gypsum plaster sandwiched between two sheets of thick paper. The drywall concept dates back to 1894 when Augustine Sackett and Fred Kane created Sackett Board. Sackett Board was made of plaster layered within 4 plies of wool felt paper. The United States Gypsum Corporation bought Sackett Plaster Board Company in 1910 and later introduced a product called Sheetrock which was an improved drywall panel that offered a panel that has more fire resistant properties and that is much easier to install.

Between the years of 1910 and 1930 there were several improvements made to the drywall panel such as creating a process to wrap the edges, eliminating the two inner layers, replacing the outer two exposed surfaces with paper-based products instead of wool felt paper, and introducing air-entrainment technology which made the panels lighter and more flexible. All of these improvements combined, created the drywall board commonly used in today's interior construction applications of commercial and residential structures. As a result, today over 20 billion square feet of gypsum board is manufactured annually to meet the demands of the United States and Canada alone.

Drywall panels are commonly manufactured in 4 ft×8 ft sheets and come in a variety of thicknesses ranging from ¼ inch to 1 inch thick panels. However, the most commonly used drywall panels are ¼ inch and ⅝ inch thick panels.

In the construction of homes, buildings, and other structures, it is common for Drywall to be used as the primary surface for interior wall and ceiling coverings. Drywall has many advantages over similar building materials when used for wall and ceiling coverings including; ease of installation, fire resistance, sound dampening capabilities, and economics. While drywall remains the preferred building material used in these applications, there are several weaknesses inherent to drywall and there are many areas in which drywall could be improved.

One weakness of drywall is the weight of the drywall panel itself. A standard ½″×4′×8′ panel weighs in excess of 50 lbs making it very difficult for installers to handle for extended periods of time. One known alternative to produce a lighter drywall panel is explained in U.S. Pat. No. RE44070 (the '070 patent). The '070 patent discloses a light weight gypsum panel created by foaming gypsum slurry used in the internal core layer of the panel and then utilizing a non-foamed layer of gypsum slurry to produce a high density layer on each side of the outer exposed surfaces. Though this method creates a lighter panel, the difference in weight is not significant enough to justify the added cost of the panel; therefore many contractors continue to use standard drywall.

Drywall panels share other common weaknesses that are often encountered during or after installation such as; the inability to retain a screw without an additional anchoring, the ease of damage due to brittleness during common construction practices, the breakage due to brittleness, and the lack of resistance to impact.

The inability for a drywall panel to retain a screw has created an entirely new industry solely dedicated to wall anchors. When homeowners, contractors or residents hang items on the wall, a drywall anchor is often required to prevent the screw or nail from retracting over time. Many of these anchors cannot be removed once they are installed or they leave oversized holes that require repair and painting if the anchor fails or does need to be removed.

Drywall is commonly broken, cracked, or damaged on jobsites or in transit due to its brittle nature. If a corner or edge of a drywall panel hits an opposing surface with minimal force, the drywall panel is often damaged and results in a needed repair. Panels ½ inch or ⅝ inch thick are the two most commonly used panels because it takes a nominal thickness of this magnitude to achieve the required strength needed in ceiling and wall applications. However, in ceiling applications a common problem encountered is sagging due to a combination of greater spans between fastening points and the overall weight of the drywall panel.

According to the National Gypsum Company and multiple other sources, the R-Value (measure of thermal resistance) for a ½″ thick drywall panel is approximately 0.45. In a wall or ceiling application where drywall is commonly installed, insulation is always required in the wall cavity or ceiling cavity of the space between the conditioned and unconditioned air. The insulation requirement in these applications routinely calls for insulation that is a minimum 6 inches thick. In attic applications, loose fill insulation ranges from 12-30+ inches depending on the climate zones in which the structure resides.

A common area of concern for residents and contractors when it comes to drywall panels is the attic space. Attics are routinely utilized for HVAC systems, plumbing pipes, cables and wires, vents etc.

when a home is constructed. Residents or tenants often times utilize attic space for additional storage needs. Additionally, attics are routinely visited to service HVAC units and change air filters. Regional building codes require specific amounts of attic insulation which is driven by the climate in a particular region. Though several types of insulation can be used in the attic to achieve a specified R-value, one of the most prevalently used types for attic space is blown insulation. When attics are insulated with blown insulation, the space between the rafters/joists is insulated and the rafters/joists themselves are buried in insulation as well creating a blanket of insulation. The blanket of insulation covering the rafters/joists make it very difficult to find a safe place to step in the event someone needs to access certain areas of the attic. As a result multiple injuries occur every year due to people stepping through or falling through the attic floor which is typically the drywall ceiling in the conditioned air space.

The combination of blown insulation and poor compressive and tensile strength of drywall can be a potentially very dangerous environment in attic space. OSHA has recognized the specific dangers associated with working in attics. OSHA has specified certain requirements for working in attics that employers must comply with to ensure their employees remain safe while in these potentially dangerous environments. However, OSHA does not monitor attic activity once a home is built. An unaware or uneducated homeowner not properly equipped and trained creates an even more dangerous situation.

Another area of concern regarding drywall is the potential for mold growth. Mold growth and the health hazards associated with living or working in a mold infested home, building or environment require serious attention. Eradication or treatment of mold and the steps involved depend when dealing with paper substrates. Mold growth on drywall is a very common area where mold may occur especially in moist or damp areas. The removal and remediation for mold in drywall requires the removal of the drywall which can often be a substantial area depending on how long the mold has been there. Mold is treatable and can be removed if detected. However, mold often times grows in areas which are undetectable without special equipment such as in a wall or ceiling cavity.

In a wall cavity humidity is often found creating an ideal environment for mold growth. Wall cavities are easily forgotten about due to the fact that they are often covered up with drywall once a structure is complete. In common construction practices, drywall is hung on the interior walls and ceilings and then painted. Once the drywall is hung and painted, the wall cavity is no longer visible and remains unmonitored. Often mold is able to grow and spread in the wall cavity of a structure for months and in many cases years undetected. Residents of a home can be suffering from chronic upper respiratory complications as a result of mold and not realize it because it is not visible.

Others have tried to improve the properties of gypsum for other areas such as tiling. U.S. Pat. No. 4,514,471 relates to forming gypsum tiles for replacing hard porcelain tiles having a gypsum substrate and coating an electron beam curing resin composition on the surface of the gypsum substrate to form a coated film and then curing the coated surface by irradiating with an accelerated electron beam. The purpose of this patent is to create a gypsum panel or tile having a rigid and harden surface to compete with porcelain tiles. U.S. Pat. No. 7,553,780 relates to creating a fibrous matt facing on one or both sides of the gypsum panel composed of preferentially glass fibers that are then treated with an ethylenically unsaturated resin dissolved in an ethylenically unsaturated solvent (the reactive diluent method) and exposing said surface treatment with a high energy UV radiation which then cures the resin to a hard, moisture resistant coating. These coatings are useful in creating a gypsum board suitable for places of high humidity and residual water where resistance or tolerance to high humidity and high moisture environments are required. The approaches in these patents are to create a relatively thin coating on the surface that promotes a harder, more substantial gypsum panel surface.

As mentioned, drywall possesses many advantages in ceiling and wall applications when compared to other materials on the market. However, drywall does share unique weaknesses that are inherent to the gypsum core material. The object of the present disclosure is to capitalize on the current strengths of the drywall panel but also provide solutions in the weak areas where improvement is needed.

### SUMMARY

In various aspects, the present disclosure provides composite gypsum panels that overcome one or more of the aforementioned deficiencies with conventional gypsum panels. More specifically, the disclosure relates to a coated panel that can be lighter and/or stronger than traditional drywall. The panel can have a dense coating layer, a foamed coating layer, or both a dense coating layer and a foamed coating layer. The dense coating layers and foamed coating layers can each offer certain advantages over conventional gypsum panels. Additionally, in various aspects, the composite panel includes a water-resistant barrier and increased nail and screw retention. The added benefits provided by the composite panel are derived from a urethane based adhesive coating that can include dense coatings, foamed coatings, or a combination thereof.

In one or more aspects, the present disclosure provides a composite gypsum panel that can possess any one or more of the following: more rigidity with higher flexural strength, less weight per square foot, improved thermal resistance, improved impact resistance, improved compressive and tensile strength, and improved water resistance and mold resistance. These are just some of the improved attributes and added benefits of the urethane adhesive coating in various embodiments of the present disclosure.

The present disclosure provides a composite gypsum panel in which at least one surface is coated with a urethane adhesive coating creating a composite drywall panel. The coated layer contains adhesive properties allowing it to self-adhere to the drywall panel. The urethane adhesive coating can be applied with or without a blowing agent. When a blowing agent is added to the coating, the coating can then become a closed cell foam. The urethane adhesive coating can provide a water resistant barrier to the drywall panel.

When a blowing agent is added to the coating to produce a foam, the R-value (measure of thermal resistance, thermal conduction, [time vs. temperature change]) of the composite gypsum panel can be increased significantly when compared to prior art drywall panels with the same nominal thicknesses. Once the closed cell foam is cured the drywall panel becomes a composite panel with improved structural integrity, a water and mold resistant barrier and strength impact resistance.

One object of the present disclosure relates to an insulated composite gypsum panel intended for use in wall and ceiling applications. The gypsum portion of the drywall panel used in these applications can be of minimal thickness (¼ inch) when used in the composite gypsum panel. The urethane adhesive coating or foam allows for a minimally thick drywall panel due to the structural integrity and flexural strength provided by the foam. The composite panel makes for a more rigid drywall panel; therefore reducing the likelihood of cracking or damaging the drywall during normal construction practices. Additionally, the composite gypsum panel allows for a much lighter drywall panel which will reduce sagging due to the weight of the panel and allow for easier installation in overhead applications.

Various composite gypsum panels are provided. In various regards, the composite gypsum panel contains one or more gypsum panel substrates, and a layer of a urethane adhesive coating or foam applied to a surface of at least one of the gypsum panel substrates. The urethane adhesive coating or foam can provide a variety of beneficial properties. The urethane adhesive coating or foam can have, for example, a urethane adhesive coating layer and a thick urethane foam layer. The urethane adhesive coating or foam can provide a waterproof barrier to the gypsum panel. The urethane adhesive coating or foam can inhibit mold growth in moist or humid environments. The urethane adhesive coating or foam can improve the flexural strength of the gypsum panel. The urethane adhesive coating or foam can improve the structural integrity of the gypsum panel while reducing the overall weight and gypsum used to construct said panel.

The urethane adhesive coating can include one or more additional blowing agents used to create an adhesive foam. The urethane adhesive coating can also be loaded with additional fillers for enhanced properties. The urethane adhesive coating can be a PET based urethane adhesive coating, e.g. can include terepthalic acid derived from recycled PET. The properties of the urethane adhesive coating/foam can remain unaltered even by extreme temperature ranges from −40° F. to 400° F.

In various aspects, the nail and screw retention of the composite gypsum panel is increased significantly over the screw retention of a standard gypsum panel having the same nominal thickness. The closed cell foam coating can also increase the R-value of the composite gypsum panel providing an insulated drywall panel. In some aspects, the closed cell foam coating provides improved impact resistance over a standard drywall panel with the same nominal thickness. The coating or closed cell foam coating can be altered to possess a fire-retardant properties.

In some aspects, the composite gypsum panel has a first gypsum panel substrate and a second gypsum panel substrate, and a urethane adhesive coating or foam between the first gypsum panel substrate and the second gypsum panel substrate. The composite gypsum panel can provide an improved acoustical and sound barrier properties as compared to the acoustical and sound barrier properties of a standard gypsum panel having the same nominal thickness. The composite gypsum panel can provide an improved noise reduction in adjacent rooms as compared to the noise reduction of a standard gypsum panel having the same nominal thickness. The foam or coating can also be utilized in a decoupling (sound isolation) application of transferring sound vibrations from material to material rather than through open space.

Other systems, methods, features, and advantages of the composite gypsum panels, including gypsum panels having coated or foamed layers adhered thereto, and methods of making and using thereof will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a partial cross-sectional view of one embodiment of a composite gypsum panel having a gypsum panel substrate, a urethane based adhesive layer, and a urethane based adhesive foam.

FIG. 2 is a side view of one embodiment of a composite gypsum panel having a gypsum panel substrate, a urethane based adhesive layer, and a urethane based adhesive foam.

FIG. 3 is a partial cross-sectional view of one embodiment of a composite gypsum panel showing the individual layers that make up a “sandwich” panel structure having a urethane based adhesive coating sandwiched between a first gypsum substrate and a second gypsum substrate.

FIG. 4 is a side view of one embodiment of a composite gypsum panel having a “sandwich” panel structure identifying the orderly arrangement of the two gypsum panel substrates and the urethane adhesive coating.

FIG. 5 is a cross-sectional view of one embodiment of a composite gypsum panel having a gypsum panel substrate coated with a urethane adhesive coating on one surface.

FIG. 6 is a side view of one embodiment of a composite gypsum panel having a gypsum panel substrate coated with a urethane adhesive coating on one surface.

FIG. 7 illustrates a cross sectional view of a residential structure depicting exemplary applications for a composite gypsum panel.

### DETAILED DESCRIPTION

In various aspects, the present disclosure provides composite gypsum panels that overcome the aforementioned deficiencies in conventional drywall panels. The composite gypsum panels can include one or more gypsum substrates having a layer of urethane adhesive coating applied thereto. Any reference to gypsum substrates is inclusive of state-of-the-art readily available gypsum panels or other substrates that contain a gypsum element. The composite gypsum panels can have improved waterproofing, enhanced mold inhibition characteristics, enhanced structural integrity, enhanced thermal resistivity, and/or improved screw retention as compared to conventional drywall panels.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, construction and manufacturing techniques which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’” includes “about ‘x’ to about ‘y’”.

Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The term “R-value,” as used herein, refers to the measure of thermal resistance as is routinely used in construction industries. The R-value is the ratio of the temperature difference across the insulator to the heat flux through the insulator. In the United States, R-values are typically given with the units of ft²·° F.·hr/Btu. R-values are routinely reported without units and, as used herein, unless the units are otherwise indicated the R-values are reported in U.S. units of ft²·° F.·hr/Btu.

The term “closed-cell foam,” as used herein, refers to a foam that is essentially fluid impermeable because the cells are not substantially interconnected, e.g. a blown foam having a closed-cell content of about 50 volume %, 60 volume %, 70 volume %, 75 volume %, 80 volume %, 85 volume %, 90 volume %, or more, e.g. essentially 100 volume % of the cells can be closed.

The term “about,” as used herein, refers to a range of values that is ±20%, ±15%, ±10%, ±9%, ±8%, ±7%, ±6%, or ±5% of the specified value, e.g. about 1″ refers to the range of 0.8″ to 1.2″, 0.8″ to 1.15″, 0.9″ to 1.1″, 0.91″ to 1.09″, 0.92″ to 1.08″, 0.93″ to 1.07″, 0.94″ to 1.06″, or 0.95″ to 1.05″.

In various aspects, the properties of composite gypsum panels are compared to the corresponding properties of a reference gypsum drywall panel. Unless otherwise stated, such comparisons are made between the composite panel and a reference panel having the same width as the composite panel (the comparison is made between panels having the same overall thickness) and under the otherwise same conditions. Furthermore, unless otherwise stated, all other properties (excluding thickness) of the reference gypsum drywall panel are the same as the gypsum panel substrate in the composite gypsum panel.

Test Procedure to Determine R-Values:

The test procedure used to determine the thermal resistance values contained the following: an insulated thermos containing a black body of magnetite, a heat lamp, a mirror, a device to conduct the test and hold the materials being tested in place and room temperature water.

A black body of magnetite and black polymer was melted into the bottom of a 10 oz. Thermos container, and enough water is placed inside to fill about ⅔ of the remaining volume. At this point, the black body inside is 42.18 g, and 175.00 mL of water is being used. Once the measuring device is assembled, it is placed directly under the center of a 250 W heat lamp bulb. A 12″×12″ mirror with a 1″ diameter hole cut in the center is rested on top of the Thermos. When looking down onto the mirror, the center 1″ circle of a test sample is seen. The surface of the mirror is 6″ away from the center of the heat lamp in a vertical fashion. At that time, the procedure was as follows:

1. Fill the Thermos and black body combination with 175 mL fresh room-temperature water.

2. Record the temperature of the water.

3. Fill the void at the top of the Thermos with a sample of insulation.

4. Place the Thermos centered underneath the heat lamp.

5. Place the mirror on top of the Thermos.

6. Ensure that the mirror is 6″ from the bulb.

7. Turn on the heat lamp for exactly one hour.

8. Remove the Thermos and measure and record the water temperature.

Test Procedure-to Determine Screw Retention:

The test procedure used to determine the required tension to retract a screw through various substrates included an Instron, a screw, a drill, a digital crane scale and a hydraulic jack. A screw was drilled into the substrate until the point of the screw penetrated the back of the substrate. The substrate was the placed on the Instron in a fashion where the tension could be placed on the screw and the substrate would remain in place. The hydraulic pump was the used to create the tension and the digital crane scale measured the required pounds to retract the screw from the substrate. Once the screw broke loose from the substrate, the required pounds to achieve the retraction were recorded.

Test Procedure-to Determine Sound Absorption:

The test procedure used to determine the sound absorption properties is ASTM C423. The methods tests measures sound absorption and sound absorption coefficients using the reverberation method. In general, the test is performed by measuring the sound absorption in a reverberation chamber. First, to obtain a background, the acoustical data for the sound absorption of an empty reverberation chamber is collected. The panel being tested is then mounted in the reverberation chamber using one of the mounting methods described in ASTM E795. For example, the panels can be mounted on the walls of the test chamber or, if they are intended for ceiling tiles, can be placed in a box creating an air space behind the specimen. The sound absorption is measured again with the panel in place and compared to the sound absorption of the empty chamber. The increase in absorption divided by the area of the test specimen is the dimensionless sound absorption coefficient. Sound Absorption Average (SAA) and the Noise Reduction Coefficient (NRC) can both be reported per the ASTM Standard. SAA is a single number, the average, rounding to the nearest 0.01 of the sound absorption coefficients of a material for the 12 one-third octave band bands from 200 through 2500 Hz. NRC is a single number rating, rounding the average of the sound absorption coefficients for 250, 500, 1000, and 2000 Hz to the nearest 0.05.

Composite Gypsum Panels

Composite gypsum panels are provided that overcome the aforementioned deficiencies in standard gypsum drywall panels such as those used for wall and ceiling constructions applications. The composite gypsum panels contain one or more gypsum panel substrates and one or more layers of a urethane coating. U.S. Pat. No. 4,514,471 and U.S. Pat. No. 7,553,780 create a relatively thin coating on the surface. Neither patent changes a substantial portion of the interior of the panel to make a composite structure composed of areas of traditional gypsum bound to a substantial portion of a foamed urethane adhesive. Composite gypsum panels are provided herein where the urethane layer is a substantial portion of the thickness of the composite panel, e.g. the urethane layers make up at least about 25%, 30%, 40%, 50%, 60%, or more of the thickness of the composite panel. The urethane layers are said to make up a substantial portion of the thickness of the composite panel when the thickness of the urethane layer(s) is at least 10% of the thickness of the composite panel. The composite gypsum panel can have a thickness of about ¼″ to about 2″, about ½″ to about 1″, or other thicknesses as may be required for the application.

The composite gypsum panel can have one or more gypsum panel substrates. In some aspects, the composite gypsum panel has a single gypsum panel substrate, while in some aspects the composite gypsum panel has two gypsum panel substrates having a urethane layer disposed between them. The gypsum panel substrate can have a thickness of about ¼″, about ⅜″, about ½″, about ⅝″, or other thicknesses as required for the given application.

The composite gypsum panel will have one or more urethane layers, e.g. urethane adhesive coating layers. The urethane layer can be or can include a blown foam urethane. In particular aspects, the foam urethane layer is a closed-cell foam layer. In various aspects, the thickness of the urethane adhesive layer and/or the thickness of the blown foam urethane can be about ¼″, about ⅜″, about ½″, about ⅝″, or other thicknesses as required for the given application. In some aspects the urethane layer is or contains a terephthalic acid group, e.g. a terephthalic acid group derived from polyethylene terephthalate (PET). The PET can be derived from recycled plastic bottles containing PET.

The urethane layers can be prepared in a variety of methods readily available to one of skill in the art. There are several methods for mixing the two liquid ingredients, polyol and isocyanate, that go into making a urethane. In general, the methods should be chosen for rapid mixing due to the rapid reaction of the two ingredients. Rapid mixing allows for a uniform mixture before the reaction has proceeded too far. The reaction is exothermic and so accelerates quickly to a somewhat cured, immobile state. The most familiar methods use dynamic, high shear mixing heads; high pressure, impingement mixing for spraying; or low pressure, mixing through static mixing heads. The dynamic mixing equipment is usually used in high volume applications although for coatings, high pressure or low pressure spraying is also applicable.

The urethane coatings or foams can be applied in line or off line in the manufacturing process of gypsum. In the manufacture of gypsum, the slurry is baked in an oven. Right after the oven that bakes the slurry the gypsum board is still hot. At that point a urethane application is very efficient, using the latent heat in the board to help cure a coating, film, or foamed layer. If produced in high volume, the application can be performed in line, either fully continuous or using a diverting line. For back coating a coating, film, or foamed layer the panels can be rotated face down: carefully preserving the facing side that was rotated up to keep from marking or roll burning in the oven. Afterward the panels are treated with one of the three mixing methods mentioned previously, held in line for a certain curing time, then scored and folded.

The composite gypsum panels can also be made in an off-line treatment, i.e. using gypsum panels that have already been produced in conventional gypsum manufacturing. An off-line treatment can take several approaches, although it is still beneficial to apply the coating, film, or foamed layer as soon as possible after the oven to use the heat in the board to assist the urethane curing. A spray coating, film, or foamed layer using high pressure impingement or low pressure static mixing heads can be delivered to the back side of the gypsum panel and allowed to cure before further processing. When larger applications amounts are needed a dynamic mixing head can deliver an amount of the urethane mixture to the back side of the gypsum and then the line levels the mixture before it has reacted too much to a standard height using a third layer of paper or other substrate on an overhead roll much like how the gypsum slurry is handled now.

In some aspects, the urethane film or foamed layer can be produced on a different line altogether and then married to a gypsum panel using an adhesive. This method can still use the latent heat in the gypsum curing process to cure the adhesive which itself can be an additional layer of urethane at a high density. This method can be useful for generating layers of varying densities.

In various aspects, the composite gypsum panels include a foamed layer of urethane. A solid foam, as a structural material, is a solid containing voids of air or gas. These voids can be created in a variety of ways. A few examples would be through the use fillers containing voids or pockets of gas that can be added, gases or air can be injected and frothed, expanding agents or blowing agents such as low melting point liquids that turn to gas can be included, or powders that will soften and expand at higher temperatures can be added. Also urethane foams can also be blown with added water, the water reacting with the isocyanate groups to produce carbon dioxide. The foam can be chemically foamed through the use of a blowing agent or it can be mechanically foamed with a gas. Examples of blowing agents can include low boiling point hydrocarbons such as cyclopentane and n-pentane, water, hydrofluorocarbons, and inert gases such as air, carbon dioxide and nitrogen.

The density of the foam can be controllably varied by adjusting the foaming/blowing conditions and/or by the use of different additives and blowing agents. For different applications it is beneficial to be able to vary the density of the foam since different densities have different properties. For instance a lite weight foam can be better for insulation, air permeability, higher moisture vapor transport, and pricing; whereas a more dense foam can be better for adhesive properties, nail retention, flexural strength, lower moisture vapor transport rates, and sound abatement. For urethane foams described herein, density ranges of about 0.5 to 10 pound per cubic foot densities are good for insulation properties. However the limiting range cannot be determined by looking at one property alone. For instance a foam having a density of about 16 to 36 pound per cubic foot can have good insulation values while at the same time provide additional strength and needed nail or screw retention over low density foams. For adhesive purposes a denser, stronger foam in the range of 24 to 60 pounds per cubic foot or even completely unblown material at 70 pounds per cubic foot can be used. Sound abatement can be improved when the density of the foam itself varies within the layer or layers applied such as a higher density (10-70 pound) changing to a lower density (0.5-10 pound) and the back up to higher density (10-70 pound), embedding the weaker low density foam between two highly structured, dense, and adhesive outer layers. In this method the average density of the layer might be considered low even though within the layer are much higher density areas.

Wall and ceiling applications require a conventional drywall panel to be a minimum of ½ inch thick or in many instances thicker to achieve the required strength and durability necessary for these applications. A ½ inch or thicker drywall panel of gypsum is extremely heavy and difficult to handle especially in overhead applications. Moreover, the thicker drywall panels used in the art still lack impact resistance and can be easily damaged. The present disclosure provides a light weight panel making installers jobs easier, less strenuous and safer in overhead ceiling applications. The composite gypsum panel can have a weight that is at least 20% less, at least 30% less, at least 40% less, or at least 50% less than the weight of a gypsum drywall panel having the same overall thickness. In various aspects, the composite gypsum panel has an impact resistance that is greater than the impact resistance of a gypsum drywall panel having the same overall thickness.

The thermal resistance provided by the composite gypsum panels of the present disclosure reduces the amount of insulation the wall or ceiling cavity requires and in some cases may eliminate the need for additional insulation depending on the thicknesses of the panels. The composite gypsum panels of the present disclosure can, at a nominal thickness of ½ inch, provide nearly 8.45 times the thermal resistance value when compared to a standard ½ inch drywall panel commonly used today. See Table 1. In various aspects, the composite gypsum panel has an R-value that is about 5×-25×, about 10×-20×, or about 12×-18× the R-value of a standard gypsum panel having the same total thickness.

TABLE 1
Measured R-Values of existing products compared to
a urethane composite gypsum panel of similar thickness.

| | R-Value |
|---|---|
| ½″ Drywall | 0.45 |
| ½″ Plywood | 0.63 |
| ½″ Composite Panel (.25″ | 4.25 |
| gypsum & .25″ Closed Cell | |
| Foam | |

Another object of the present disclosure relates to a composite gypsum panel for use as a drywall panel. The composite gypsum panel can have a gypsum panel substrate in which one surface of the gypsum panel substrate is coated with the urethane adhesive coating. The coated side of the composite gypsum panel would face inwards towards the wall or ceiling cavity. The coated side of the composite gypsum panel creates a waterproof and mold resistant barrier. The waterproof and mold resistant surface created by the urethane coating provides a composite gypsum panel for use in applications where humidity and moisture are common such as ceiling or wall cavities found in basements, attics or other exterior wall in residential, commercial or industrial applications where drywall is commonly used. The waterproof and mold resistant barrier provides protection in these areas which are conducive for mold growth but cannot be easily monitored without specialized equipment. The composite gypsum panel has a water resistance and/or a mold resistance that is greater than a reference gypsum panel.

In various embodiments, the composite gypsum panels have increased screw retention, rigidity and/or improved structural integrity as compared to a conventional gypsum panel. In a ¼ inch thick drywall panel, the required tension to retract the screw is roughly 25 lbs. A composite gypsum panel increases the required tension to a minimum of 150 lbs to retract the same screw out of the ¼ inch thick drywall. See Table 2. Additionally, the composite gypsum panels of the present disclosure can increase nail and screw retention of the drywall panel significantly.

TABLE 2
Measured Screw Retention of conventional panel
compared to urethane composite gypsum panel.

| | |
|---|---|
| ¼″ Drywall | 25 lbs |
| ¼″ Drywall with ¼″ | 150 lbs |
| coating | |

Composite gypsum panels are provided having a “sandwich” like panel structure in which one gypsum panel substrate is adhered to a second gypsum panel substrate utilizing the urethane adhesive coating. The adhesive coating sandwiched between the two drywall panels provides an acoustical panel for use in wall and ceiling applications in home theatres, nurseries, multifamily housing, apartments, hotels etc. . . . The acoustical panel can reduce the noise in adjacent rooms when compared to traditional drywall panels. It is well known that foamed structures with areas of low density (foamed cells) surrounded by areas of increased density are useful as sound deadening barriers. Though there is prior art utilizing a gypsum sandwich panel today, the urethane adhesive coating used in the present disclosure provides improved structural integrity with better adhesion and sound dampening capabilities than competing products.

Describing now in more detail the drawings, numerals are included to specify unique aspects and like components of the drawings throughout various views or intended applications. Utilization of each object of the present disclosure may be used in any wall or ceiling application as deemed necessary.

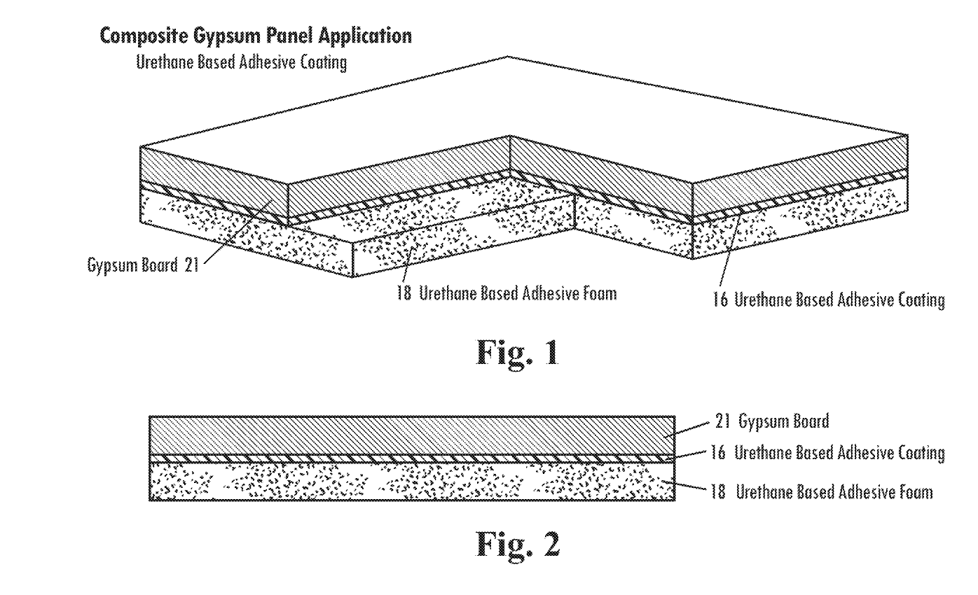

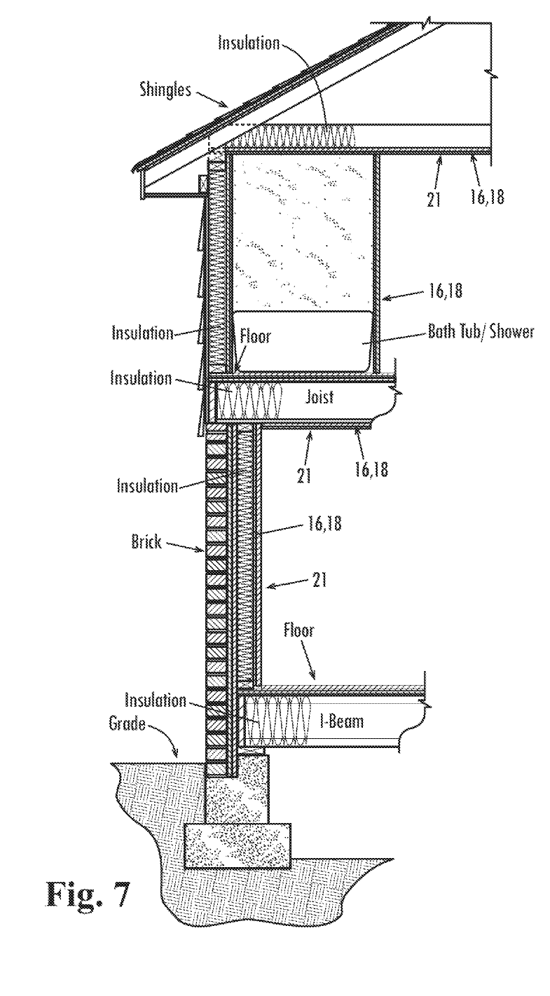

FIG. 1 represents a composite gypsum panel having a gypsum panel substrate (21) in which one side of the gypsum panel substrate (21) is coated with a urethane adhesive foam (18). The heat sink of the gypsum panel prevents complete blowing of the foam on the surface of the gypsum providing a localized area of increased density between the gypsum panel and the foamed layer. The urethane adhesive is applied and creates a urethane adhesive coating (16) that self-adheres to the panel and simultaneously creates the urethane adhesive foam (18). The resulting composition gypsum panel has a gypsum panel substrate (21) and a urethane based foam layer (18) having sandwiched there between a urethane based adhesive coating (16). The composite gypsum panel that is formed provides increased strength, rigidity and R-value. This panel as illustrated in FIG. 7 is intended for interior walls and ceilings in residential or commercial building applications. The exposed surface of the gypsum panel (21) will face opposite the wall or ceiling cavity while the urethane adhesive foam surface will face inwards towards the wall or ceiling cavity. By positioning and installing the panel in this manner, the panel becomes very versatile and useful for many applications. In a moist environment such as a basement or in any exterior wall cavity of a structure where mold is prone to grow and undetectable without specialized equipment, this panel is ideal as the urethane adhesive coating inhibits mold growth.

The composite gypsum panel disclosed in FIG. 1 is also intended for use in overhead applications such as a ceiling which often time provides the flooring for an attic. The urethane adhesive foam (18) in this application would face upwards towards the unconditioned attic space. When the composite gypsum panel is installed in this manner a solid floor is provided in the attic protecting people from falling through or becoming injured in the event of a missteps. The urethane adhesive foam (18) is able to hold the weight of a human as the rigidity and strength is similar to that of wood.

Additionally, the urethane adhesive foam (18) is a closed cell foam which not only provides a water and airtight barrier, but in addition, provides greater thermal resistance values in walls and ceilings where heat loss is a common problem. The nominal thickness of the panel revealed in FIG. 1 would be the same or similar to that of common drywall panels used today, however, the panel would require less gypsum decreasing the overall weight. The gypsum panel (21) can be installed in the field utilizing standard gypsum panel installation practices and utilizing standard gypsum fasteners requiring no specialized equipment.

FIG. 2 represents a side view orientation of FIG. 1 showing the orderly arrangement in which the gypsum panel (21) and the urethane adhesive foam (18) are oriented. The urethane adhesive coating (16) reveals the adhesion point where the coating (16) meets the gypsum panel (21) and self-adheres to the panel prior to foaming. The urethane layers, including the urethane based adhesive coating (16) and urethane adhesive foam (18) can be about 35%-60% of the total thickness of the composite gypsum panel. In various aspects, the composite gypsum panel has a total thickness of about ½″ and the urethane layers have a combined thickness of about ¼″.

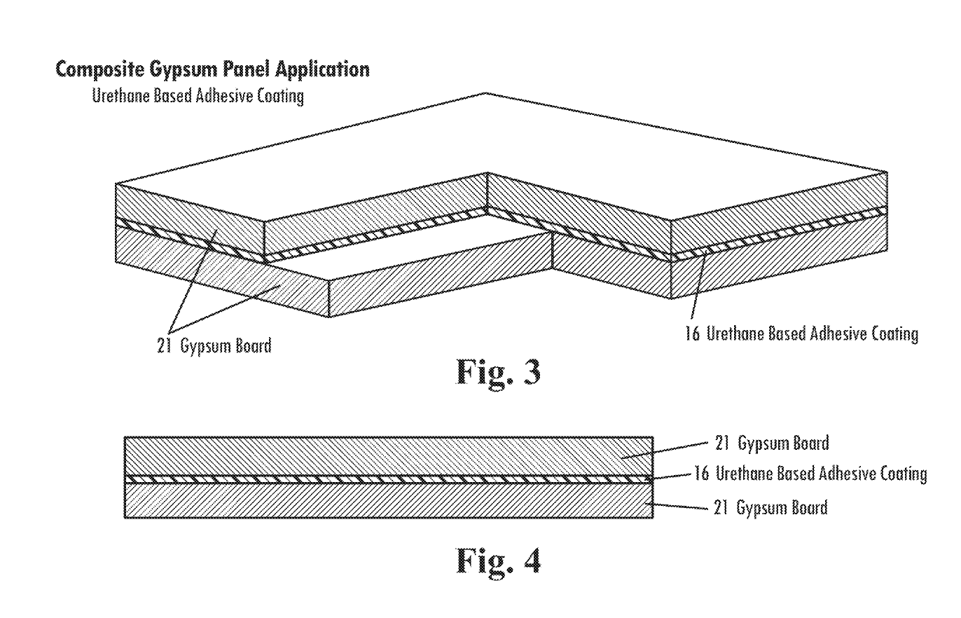

FIG. 3 illustrates a composite gypsum panel having a “sandwich” panel structure in which one gypsum panel substrate (21) is adhered to an additional gypsum panel substrate (21) utilizing a urethane adhesive coating. The urethane adhesive coating increases the rigidity of the sandwich panel and provides an acoustical sound barrier. The sandwich panel is intended for use in theatre rooms, multifamily housing, apartments, nurseries and any other facilities or rooms where noise dampening or capturing is desired. The urethane adhesive coating (16) also provides a gypsum wall or ceiling with increased screw retention and strength allowing for the hanging of speakers, pictures etc. . . . on the wall or ceiling without the use of specialized drywall anchors.

FIG. 4 represents a side view orientation of FIG. 4 showing the orderly arrangement of the gypsum panel substrate (21) followed by a urethane adhesive coating (16) and then by an additional gypsum panel substrate (21).

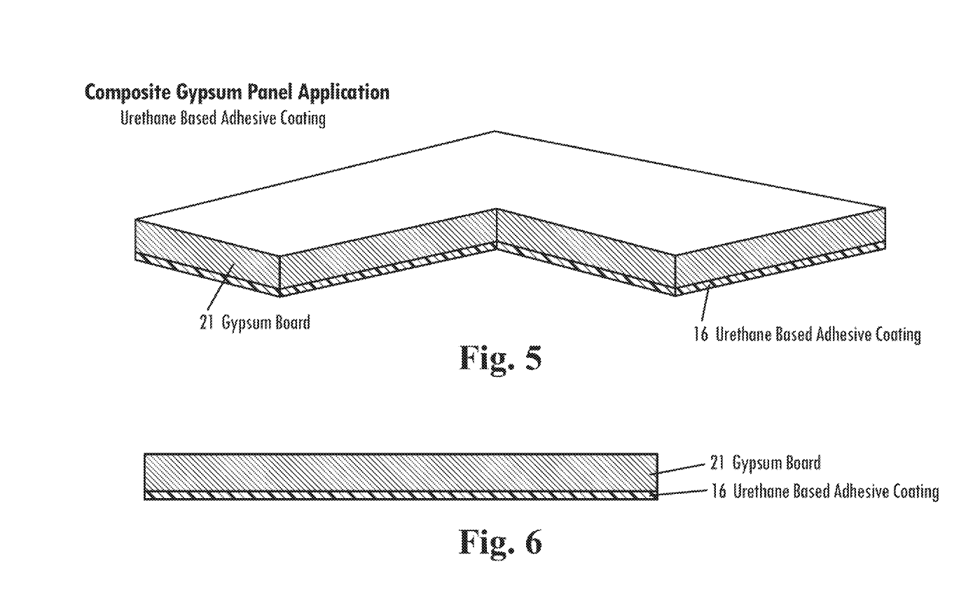

FIG. 5 represents a composite gypsum panel having a gypsum panel substrate (21) in which one facing surface of the panel is coated with a urethane adhesive coating (16). The urethane adhesive coating (16) self-adheres to the panel and increases the rigidity, durability, and screw retention of the panel while also creating a mold resistant barrier. The amount of gypsum required in the panel is reduced significantly as the coating provides the structural integrity needed for wall and ceiling applications. The urethane adhesive coating (16) faces inward towards the wall or ceiling cavity while the opposing gypsum panel (21) surface faces the interior conditioned air space.

The composite gypsum panel illustrated in FIG. 5 is ideal in moist humid environments such as a basement or attic. The wall cavities in basements routinely create an environment for mold growth due to the humidity. Urethanes are well known to inhibit mold growth which makes for an ideal panel in these environments. The interior surface remains the same as traditional drywall allowing for easy painting and repair, however, the panel provides protection against mold in the hard to monitor areas. Additionally, the urethane adhesive coating (16) creates a water proof barrier protecting the drywall panel from swelling and damage.

FIG. 6 represents a side view orientation of FIG. 5 showing the orderly arrangement of the gypsum panel substrate (21) and the urethane adhesive coating (16). The urethane adhesive coating (16) is applied to one surface of the gypsum panel substrate (21) leaving the opposing surface of the gypsum panel substrate (21) exposed.

FIG. 7 illustrates some intended uses for the composite gypsum panels represented in FIG. 1, FIG. 3 and FIG. 5. The intended uses or applications for these composite gypsum panels include but are not limited to interior surface panels for wall and ceiling applications in residential, commercial or industrial structures.

We claim:

1. A composite gypsum panel, the composite gypsum panel comprising:
one or more gypsum panel substrates, and
a layer of a urethane adhesive coating applied to a surface of at least one of the one or more gypsum panel substrates.

2. The composite gypsum panel of claim 1, wherein the urethane adhesive coating provides a waterproof barrier to the gypsum panel.

3. The composite gypsum panel of claim 1, wherein the urethane adhesive coating inhibits mold growth in moist or humid environments as compared to the otherwise same gypsum panel except without the urethane adhesive coating when measured under the otherwise same conditions.

4. The composite gypsum panel of claim 1, wherein the urethane adhesive coating improves the flexural strength of the gypsum panel as compared to the otherwise same gypsum panel except without the urethane adhesive coating when measured under the otherwise same conditions.

5. The composite gypsum panel of claim 1, wherein the urethane adhesive coating improves the structural integrity and flexural strength of the gypsum panel while reducing the overall weight and amount of gypsum used to construct the composite panel, when the composite panel is compared to a gypsum panel of the same thickness without the urethane adhesive coating when measured under the otherwise same conditions.

6. The composite gypsum panel of claim 1, where the urethane adhesive coating is a foam created by the addition of one or more additional blowing agents used to create the foam.

7. The composite gypsum panel of claim 1, where the urethane adhesive coating comprises one or more additional fillers for enhanced properties.

8. A composite gypsum panel comprising:
a) one or more gypsum panel substrates; and
b) a urethane adhesive coating comprising a polyethylene terephthalate (PET).

9. The composite gypsum panel of claim 8, wherein the PET comprises recycled PET.

10. The composite gypsum panel of claim 8, wherein the PET is foamed.

11. The composite gypsum panel of claim 8, wherein the urethane adhesive coating comprises additional fillers for enhanced properties.

12. A composite gypsum panel comprising: a) one or more gypsum panel substrates b) a urethane foamed adhesive coating.

13. The composite gypsum panel of claim 12, wherein the properties of the urethane adhesive coating/foam are unaltered by extreme temperature ranges from −40° F. to 400° F.

14. The composite gypsum panel of claim 12, wherein the screw retention of the composite gypsum panel is increased significantly over the screw retention of a standard gypsum panel having the same nominal thickness.

15. The composite gypsum panel of claim 12, wherein the closed cell foam coating increases the R-value of the composite gypsum panel providing an insulated drywall panel.

16. The composite gypsum panel of claim 12, wherein the closed cell foam coating provides improved impact resistance over a standard drywall panel with the same nominal thickness.

17. The composite gypsum panel of claim 12, wherein the closed cell foam coating is a fire retardant foam.

18. The composition gypsum panel of claim 12, wherein the urethane foam coating is comprised of polyethylene terephthalate as a component.

19. A composite gypsum panel wherein the composite panel comprises on or more layers bound together with a urethane adhesive coating or foam, wherein the composite gypsum panel comprises a first gypsum panel substrate and a second gypsum panel substrate, with said adhesive coating sandwiched between said gypsum panel layers.

20. The composite gypsum panel of claim 19, wherein the composite gypsum panel provides an improved acoustical and sound barrier properties as compared to the acoustical and sound barrier properties of a standard gypsum panel having the same nominal thickness.

21. The composite gypsum panel of claim 19, wherein the composite gypsum panel provides a significant noise reduction in adjacent rooms as compared to the noise reduction of a standard gypsum panel having the same nominal thickness.

22. The composite panel of claim 19, wherein the composite gypsum panel provides improved acoustical sound barrier properties as compared to the acoustical and sound barrier properties of a state-of-the-art gypsum panel through a decoupling mechanism of sound insulation thusly transferring vibrations from material to material.

23. The composite panel of claim 19, wherein the urethane is comprised of a polyethylene terephthalate component.

24. A composite gypsum panel wherein one or more layers of a gypsum panel are bound together with a foamed urethane adhesive coating.

25. The composite gypsum panel of claim 24 whereas one or more layers of a gypsum panel are bound together with a foamed urethane adhesive coating comprised of polyethylene terephthalate as a component.

26. A method of making a composite gypsum panel, wherein the composite gypsum panel comprises:
one or more gypsum panel substrates, and
a layer of a urethane adhesive coating applied to a surface of at least one of the one or more gypsum panel substrates;
wherein the method comprises:
mixing a polyol and an isocyanate to form a mixture,
applying the mixture to the surface of the at least one of the one or more gypsum panel substrates,
curing the mixture to form the layer of the urethane adhesive coating on the at least one of the one or more gypsum panel substrates to form the composite gypsum panel.

27. The method of claim 26, wherein the mixing comprises applying the polyol and the isocyanate using a spray gun, wherein a stream comprising the polyol and a stream comprising the isocyanate are mixed within the gun before being applied to the surface.

28. The method of claim 27, wherein the spray gun is a high pressure impingement spray gun.

29. The method of claim 26, wherein the at least one of the one or more gypsum panel substrates is at an elevated temperature as compared to room temperature, and
wherein the curing comprises heating the mixture on the surface of the substrate using the heat from the gypsum panel substrate.

30. The method of claim 29, wherein the method is performed in-line with the production of the at least one of the one or more gypsum panel substrates, and
wherein the at least one of the one or more gypsum panel substrates is at an elevated temperature from an oven bake to produce the gypsum panel substrate.

31. The method of claim 26, wherein the layer of the urethane adhesive coating is a foam, and
wherein the mixing step comprises mixing a blowing agent in the mixture.
